(19) United States
(12) Patent Application Publication
(10) Pub. No.: US 2026/0330523 A1
(43) Pub. Date: Oct. 22, 2026

(54) A PERSONALIZED CONTENT DELIVERY SYSTEM

(71) Applicant: Avery Dennison Retail Information Services LLC, Mentor, OH (US)

(72) Inventors: Matthew JONES, Bentonville, AR (US); Josh POPE, Bentor, AR (US)

(21) Appl. No.: 19/106,809

(22) PCT Filed: Sep. 7, 2023
(86) PCT No.: PCT/IB2023/058885

§ 371 Date: Feb. 26, 2025

Related U.S. Application Data
(60) Provisional application No. 63/375,065, filed on Sep. 9, 2022.

(51) Int. Cl. G06Q 30/0601

(52) U.S. Cl. CPC G06Q 30/06211

(57) ABSTRACT

The present subject matter disclosed herein relates to a personalized content delivery system that may include a personalized content delivery device communicatively coupled to a portable communication device of a user via a communication network. The personalized content delivery device may be configured to identify an identity of the user and deliver a personalized template for display on the portable communication device of the identified user, and the personalized template may be embedded with personalized content generated based on the identity of the identified user.

### FIELD OF THE INVENTION

The present subject matter relates to devices and methods of managing user information, and more particularly to a device and method of managing user information to provide user/customer support while shopping.

### BACKGROUND

A retail shopping environment experience is often the determining factor for whether a retail customer will purchase a product. Offering discounts on products is one of the typical ways of earning the loyalty of customers. Retailers typically use coupons as a way to advertise and discount their products to compete with other similar products in the market. Coupons are typically rendered as paper coupons or e-coupons. Although several attempts have been made by retailers to deliver personalized e-coupons to targeted individual customers based on their location, time of the day, purchasing behavior and the like, the existing e-coupon delivering systems are still not configured to directly deliver a customized coupon to the customer's mobile/communication device. For example, an existing art discloses a method of generating a generic e-coupon, such as in the form of a generic e-coupon identifier (ID) to a mobile device using one or more transmission media. The mobile device receiving the generic e-coupon ID, recognizes the same and then using the information in the generic e-coupon ID, personalizes the generic e-coupon. Thus, the existing e-coupon delivery systems still rely on the consumers' mobile device to identify and transform the generic e-coupon ID into a personalized one. There is therefore a need for a more reliable and efficient system of delivering personalized contents to consumers.

Besides offers and promotions, customers at a retail store also like to be kept engaged by service staff that can interact and offer advice on new products and recipes or answer their questions. Most customers expect that when a product is not found on the shelf, the service staff should pinpoint the location and real-time stock level of every item at a glance or suggest different items based on that customer's shopping habits. Therefore, there is a need for the service staff to be constantly aware of the stock and the new products available in and around their assigned aisle, besides the customer's shopping preferences. Even in unmanned retail stores/walk in-walk out stores the customers expect to be presented with alternatives for missing products on the shelf or to new products of the same kind. Therefore, besides promotions and offers, there is also a need to display alternate items and their price information for the sake of improving customer convenience and satisfaction. In addition, more and more customers also seek to have shopping experiences that are application agnostic. There is therefore a need for a comprehensive system capable of generating and delivering personalized content for display on portable communication devices of different categories of users without the need for the installation of any additional application program for communication with the content builder or for receiving the customized content.

Accordingly, improvements over conventional systems are needed.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

In some embodiments, the present subject matter includes a personalized content delivery system that generates and delivers a personalized template to be displayed on a portable communication device of a user. In some embodiments, the personalized content delivery system is configured to generate a personalized template embedded with personalized content for display on a portable communication device of a user.

In some embodiments, the personalized content delivery system comprises a personalized content delivery device communicatively coupled to the portable communication device of the user via a communication network. The personalized delivery device is configured to generate a personalized template for display on the portable communication device of the user. In some embodiments, the personalized content delivery device is a proxy server.

In some embodiments, the personalized content delivery device comprises a plurality of functional units including one or more of a user identifier unit, a user data extractor unit, a font style and font size recognizer unit, a content builder unit, a user interface template selector unit and a personalized template renderer unit. In some embodiments, the personalized content delivery device comprises a processor and a memory communicatively coupled to the processor. In some embodiments, the memory stores data including user identity data, user history data, user location data, user font style and font size data, user interface template data and other data. The personalized content delivery device may be part of or include one or more of a server, a laptop, a desktop computer, a plurality of computing devices, or a virtual machine, or combinations thereof.

In some embodiments, the personalized content delivery device is configured to identify a user based on user identity information received from the portable communication device of the user. In some embodiments, the portable communication device is selected from the group consisting of a mobile phone, Point-Of-Sale (POS) device, a smart phone, a tablet, a laptop, handheld computer. In some embodiments, the user identity information is selected from a group consisting of a unique user ID, an employee ID, an application ID, a mobile number, a loyalty card number and social security ID.

In some embodiments, the processor acquires the user identity information from the portable communication device via the communication network when the user taps or scans a tag. In some embodiments, the tag comprises a NFC tag, a barcode tag, a matrix code tag, a QR code tag, or combination thereof. In some embodiments, the portable communication device is operated/accessed through a browser or an application.

In some embodiments, the processor acquires the user identity information from the browser of the portable communication device via the communication network when the user taps or scans the tag. In some embodiments, the processor acquires the user identity information from the browser when user taps or scans the tag using built-in camera or NFC reader associated with the portable communication device.

In some embodiments, the processor acquires the user identity information from the application associated with the portable communication device via the communication network when user taps or scans the tag using the application. In some embodiments, the user identity information from the portable communication device is transmitted to the processor by tapping the communication device on the NFC tag using one of the built-in NFC reader or the application associated with the portable communication device. In some embodiments, the user identity information from the portable communication device is transmitted to the processor by scanning the barcode or matrix code or the QR code using one of the built-in camera or the application associated with the portable communication device.

In some embodiments, the user identifier unit is configured to utilize the user identity information and the user identity data corresponding to the user identity information to identify the identity of the user. In some embodiments, the user identity data includes user profile information.

In some embodiments, the personalized content delivery device is configured to generate a personalized content based on extracted data corresponding to an identity of the identified user. In some embodiments, the extracted data comprises a user identity data, a user history data, a user location data, a user font style and font size data, and other data.

In some embodiments, the extracted data further comprises data from a database associated with a merchant facility. In some embodiments, the data from the database comprises at least one of store's planogram information, shelf's images with location, geospatial information, user history data, images of the store floors, historical sales, location of the communication device, product code Lookup table, information about products sold in the store, products stored in the shelves, product manufacturing and expiry date information.

In some embodiments, the personalized content includes customized discounted price information for a product. In some embodiments, the personalized content includes customized alternative choices for a product. The customized alternative choices comprises at least one of alternative similar products and alternative store name with location for the product.

In some embodiments, the personalized content includes customized discounted price on required products for the user. In some embodiments, the required products being identified by the personalized content delivery device by tracking and accessing at least one of the application, online browsing data, and recently viewed items on-line by the user.

In some embodiments, the personalized content delivery device is configured to select a user interface template based on the identity of the identified user. In some embodiments, the personalized content delivery device is configured to embed the generated personalized content into a selected user interface template to generate the personalized template. In some embodiments, the personalized template comprises a template with customized shape and size for the identified user.

In some embodiments, the personalized content delivery device is configured to display the generated personalized template on the portable communication device of the user. In some embodiments, the personalized content delivery device is configured to identify one or more characteristics related to the portable communication device. In some embodiments, the personalized content delivery device is further configured to display the generated personalized template on the portable communication device of the user based on the identified one or more characteristics. In some embodiments, the one or more characteristics related to the portable communication device comprises screen size of the portable communication device, screen color capabilities of the portable communication device, bandwidth connection or internet speed of the portable communication device.

In some embodiments, the personalized content delivery device comprises a memory, and a processor communicatively coupled with the memory. The personalized content delivery device is configured to perform a series a method steps. The set of steps is not limited to but includes identifying the user based on the user identity information received, building a personalized content based on extracted data corresponding to an identity of the identified user, selecting a user interface template based on the identity of the identified user, embedding the generated personalized content into a selected user interface template to generate the personalized template and displaying the generated personalized template on the portable communication device of the user.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF DRAWINGS

FIG. 1 illustrates an exemplary environment of personalized content delivery system for delivering a personalized template with personalized content to a user, in accordance with some embodiments of the present subject matter;

FIG. 2 illustrates a block diagram of a personalized content delivery device, in accordance with some embodiments of the present subject matter;

FIG. 3A illustrates an exemplary illustration of a personalized template to be displayed in a portable communication device of a first user, in accordance with some embodiments of the present subject matter;

FIG. 3B illustrates an exemplary illustration of a personalized template to be displayed in a portable communication device of a second user, in accordance with some embodiments of the present subject matter;

FIG. 3C illustrates an exemplary illustration of a personalized template to be displayed in a portable communication device of a third user, in accordance with some embodiments of the present subject matter;

FIG. 3D illustrates an exemplary illustration of a personalized template to be displayed in a portable communication device of a fourth user, in accordance with some embodiments of the present subject matter; and

FIG. 4 illustrates a flowchart for representing the method steps performed by the personalized content delivery device, in accordance with some embodiments of the present subject matter.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the present subject matter can be practiced without these specific details. In other instances, well-known structures and devices are shown in block diagram form in order to facilitate a description thereof.

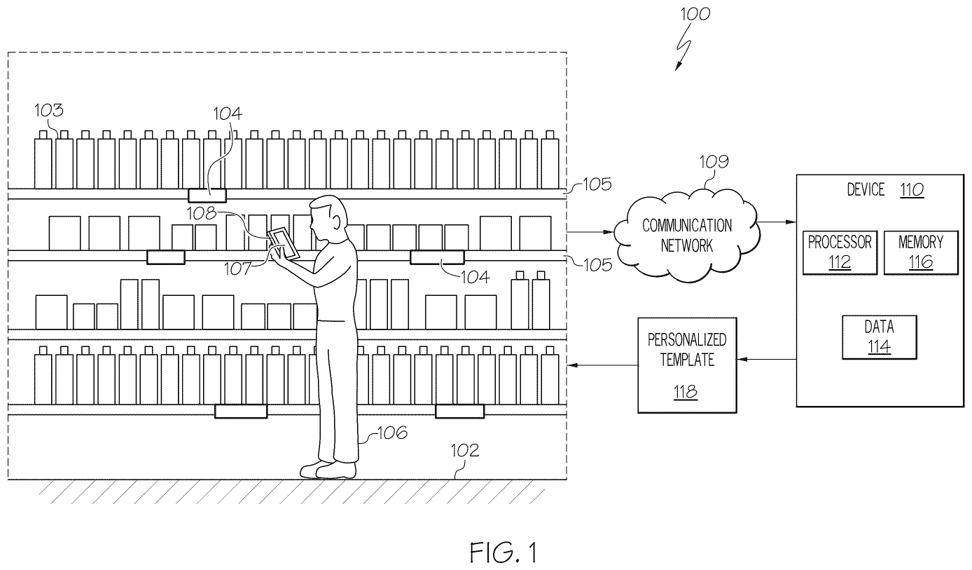

FIG. 1 illustrates an exemplary environment of personalized content delivery system 100 for delivering a personalized template with personalized content to a user 106, in accordance with some embodiments of the present subject matter. The exemplary environment shown in FIG. 1 comprises a merchant facility 102, a communication network 109, a personalized content delivery device 110 and a database (not shown in FIG. 1) associated with the merchant facility 102. The environment of FIG. 1 is only exemplary and should not be considered as a limitation. The merchant facility 102 may be a retail store, a shopping area, an outlet, a storehouse, a super market, a showroom, and the like. The merchant facility 102 comprises a product 103, a tag 104, and plurality of shelves 105, the user 106, and the portable communication device 108. The portable communication device 108 of the user 106 and the personalized content delivery device 110 both are communicatively coupled with each other via the communication network 109. The product 103 may include, but is not limited to, an electronic item, apparel, health care products, cosmetic products, food and beverage products, and any consumer goods. The tag 104 may include one or more of a Near Field Communication (NFC) tag, a barcode tag, a QR code tag, a matrix code tag or combinations thereof. In an embodiment, the NFC tag comprises an antenna and a chip. The user 106 may be a regular customer, a new customer, a staff member or an employee. Further, the portable communication device 108 may include, but not limited to, a mobile phone, Point-Of-Sale (POS) device, a smart phone, a tablet, a laptop, and/or handheld computer. The personalized content delivery device 110 may be part of or include one or more of a server, a client, a laptop, a desktop computer, a plurality of computing devices, or a virtual machine, or combinations thereof.

In some embodiment, the database stores at least one of one or more store's planogram information, shelf images with location, geospatial information, user history, images of the store floors, location of the portable communication device 108, product code lookup table, information about products sold in the store, products stored in the shelves, or product manufacturing and expiry date information, and combinations thereof. In some embodiments, each product in the merchant facility 102 assigned with product code or ID. In some embodiments, the user history comprises one of user historical purchase, user preferences, and purchase behavior. In some embodiments, the product code Lookup table comprises plurality of product codes, wherein each of the plurality of product codes corresponds to one of specific product name, descriptions, prices, categories, product size, product color, product weight, or combination thereof. In some embodiments, the database is updated in real time by the merchant facility 102.

In an embodiment, the communication network 109 may include, without limitation, one or more of a direct interconnection, Local Area Network (LAN), Wide Area Network (WAN), wireless local area networks (WLANs), Controller Area Network (CAN), wireless network (e.g., using Wireless Application Protocol), the Internet, and combinations thereof.

In one embodiment, the tag 104 is directly adhered to, or attached to the product 103. In another embodiment, the tag 104 is directly adhered to, or attached to the plurality of shelves 105 based on different categories of the products. The different categories may include, but not limited to, type of item, size, color, and brand. The type of item may include one or more of, but is not limited to, groceries, food products, apparel products, health products, and beauty products. For example, a single tag may be installed on a shelf for one or more identical products which are arranged on the shelf. For instance, a single tag may be installed for shampoo bottles corresponding to a single brand and a color, such as ‘X’ brand with black color (e.g., for the product packaging).

In some embodiments, the tag 104 can be scanned or tapped by the user 106 via the portable communication device 108 using an application 107. In an embodiment, aa personalized content delivery device 110 may be the application 107 which is stored in the portable communication device 108 or may be downloaded from an application store. The user can access the application 107 via the portable communication device 108. Before accessing the application 107, the user 106 needs to register themselves with application 107 by providing registration details. The registration details include, but not limited to, name or user name, Date Of Birth (DOB), Phone number, password, email, and the like. Upon successful registration, a profile is created for the user 106. The user 106 can access the application 107 by providing created username and password. Further, the user 106 can tap or scan the tag 104 using the application 107. One or more functionalities (not shown in Figure) provided in the application 107 to trigger a camera (not shown in Figure) and a built-in NFC reader (not shown in Figure) to enable scanning or tapping operation for the tag 104. In some embodiments, the portable communication device 108 is operated/accessed through a browser (not shown in FIG. 1). or the application 107.

In some embodiments, the portable communication device 108 of the user 106 such as a mobile phone may directly communicate with the tag 104 such as NFC tag using the in-build NFC reader (not shown in Figure) associated with the portable communication device 108. For example, when a customer walks into a retail store, an NFC enabled mobile phone may automatically communicate with the NFC chip. The NFC chip installed or adhered to the product 103 in the store and the NFC chips may in turn connect the portable communication device 108 of the user 106 to the personalized content delivery device 110 via the browser.

In some embodiments, the tag 104 such as the QR code tag or the matric code tag or the barcode tag attached to the product 103 may be scanned from a camera of the portable communication device 108 of the user 106. In some embodiments, the portable communication device 108 begins communication with the personalized content delivery device 110 via the communication network 109 using the browser when the user 106 taps or scans the tag 104 with his/her device 108.

In some embodiments, the personalized content delivery device 110 is activated when the user 106 taps his/her portable communication device 108 on a NFC tag using the application 107 or the in-build NFC reader associated with the portable communication device 108. In some embodiments, the personalized content delivery device 110 is activated when the user 106 taps his/her portable communication device 108 scans the barcode/QR code/matrix code using the application 107 or the camera associated with the portable communication device 108.

In an exemplary embodiment, the personalized content delivery device 110 comprises a processor 112 operatively coupled to a memory 116. The memory 116 may include a volatile memory and/or a non-volatile memory. The non-volatile memory may include e.g., read-only memory (“ROM”), programmable ROM (“PROM”), erasable programmable ROM (“EPROM”), electrically erasable programmable ROM “EEPROM”), flash memory, etc. coupled with the address/data bus (not shown), wherein the non-volatile memory is configured to store static information and instructions for the processor 112. The memory 116 contains data or instructions which when executed by the processor 112 causes the processor 112 to perform a set of steps. In some embodiments, the memory 116 may store commands or data 114 relevant to at least one other component of the personalized content delivery device 110. In some embodiments, the memory 116 stores data 114 to be processed by the processor 112 for generating personalized content to be displayed on the portable communication device 108 of the user 106. In some embodiments, the memory 116 stores data 114 to be processed by the processor 112 for generating a personalized template 118 to be displayed on the portable communication device 108 of the user 106.

In one embodiment, the personalized content delivery device 110 is a proxy server. In a second embodiment, the personalized content delivery device 110 is a computer system. In some embodiments, the computer system may execute instructions retrieved from an online data storage unit such as in “Cloud” computing. In an aspect, the computer system also may include one or more interfaces, such as an interface (not shown), coupled with the address/data bus (not shown). The one or more interfaces are configured to enable the computer system to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology. The term “instructions” as used with respect to this subject matter generally indicates a set of operations to be performed on the personalized content delivery device, and may represent pieces of a whole program or individual, separable, software modules.

In some embodiments, when the portable communication device 108 is in communication with the personalized content delivery device 110, the processor 112 receives user identity information from the portable communication device 108 when the user 106 scans or taps the tag 104. For example, when the portable communication device 108 is connected to the personalized content delivery device 110 via the application 107, the personalized content delivery device 110 receives user identity information from the application 107 via the communication network 109. In other embodiments, the personalized content delivery device 110 may directly receive the user identity information from the portable communication device 108 via the communication network 109 through the browser when the user 106 taps or scans the tag 104 using the camera or the built-in NFC reader associated with the portable communication device 108. The processor 112 processes the user identity information of the user 106.

According to an exemplary embodiment, based on the user identity information received from the portable communication device 108, the personalized content delivery device 110 identifies the user 106. The personalized content delivery device 110 is configured to generate personalized content based on data corresponding to an identity of the identified user. In one embodiment, the personalized content includes customized alternative choices for the product 103. In some embodiments, the customized alternative choices comprises at least one of alternative similar products and alternative store name with location for the product 103. In a second embodiment, the personalized content includes one or more customized discounted prices on required or non-required products for the user 106. The required products may be identified by the personalized content delivery device 110 by tracking and accessing at least one of the application 107, a user history such as online browsing data, and/or recently viewed items on-line by the user 106. Further, the generated personalized content may be incorporated into the personalized template 118 for display on the portable communication device 108. The personalized template 118 generated by the personalized content delivery device 108 may be communicated to the portable communication device 108 via the communication network 109. In some embodiments, the personalized template 118 comprises a template with customized shape and size for the identified user.

In some embodiments, the personalized content delivery device 110 delivers the personalized template 118 with personalized content for display on the portable communication device 108 of the user 106. In some embodiments, the personalized content delivery device 110 is configured to deliver personalized templates with personalized content on portable communication devices of different categories of users simultaneously. In some embodiments, the personalized content delivery system comprises the personalized content delivery device 110 configured to generate one or more personalized templates for display on the portable communication devices of different categories of the users. For example, in one embodiment the user 106 may be a regular customer of a retail store. In a second embodiment the user 106 may be a new customer. In a third embodiment the user 106 may be a staff member or an employee at the retail store. In another embodiment the user 106 may include regular customers and staff members or new customers and staff members, or regular customers, new customers and staff members. The term “user” as used with respect to this subject matter generally indicates a person/persons using his/her portable communication device 108 such as a mobile phone or POS device in the merchant facility 102.

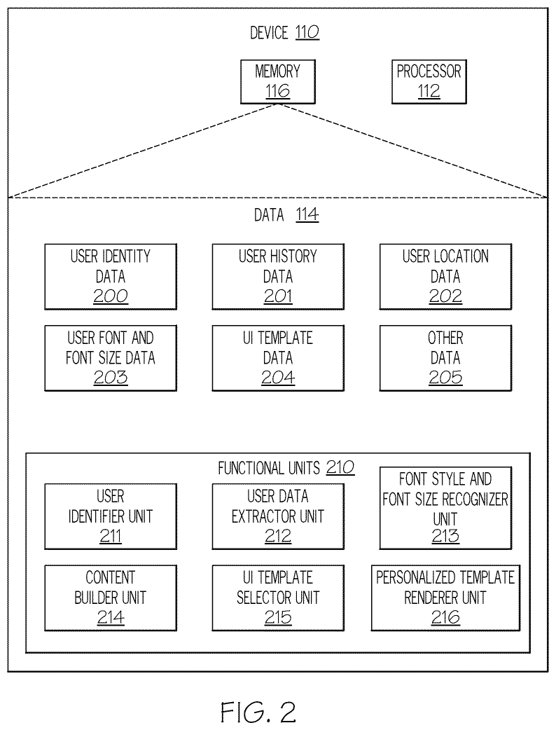

FIG. 2 illustrates a detailed block diagram of the personalized content delivery device 110 (as shown in FIG. 1), in accordance with some embodiments of the present subject matter. The content delivery device 110 comprises the processor 112 (as shown in FIG. 1) and a memory 116 (as shown in FIG. 1) communicatively coupled to the processor 112. The processor 112 is configured to execute a series of instructions (e.g., software program) that reside within the memory 116. In some embodiments, the memory 116 includes a plurality of computer readable memory units that constitute data 114 for the personalized content delivery device 110.

In an exemplary embodiment, the data 114 stored in the form of a plurality of memory units in the personalized content delivery device 110 may include a user identity data 200, a user history data 201, a user location data 202, a user font style and font size data 203, a user interface template data 204 and other data 205. Additionally, the personalized content delivery device 110 also comprises a plurality of functional units 210 including a user identifier unit 211, a user data extractor unit 212, a user font style and font size recognizer unit 213, a content builder unit 214, a user interface template selector unit 215, and a personalized template renderer unit 216. The functional units 210 are configured to execute instructions using the data 114 stored in the memory 116 to cause the personalized content delivery device 110 to perform specific actions and exhibit specific behavior, such as described herein.

In an exemplary embodiment, the user identifier unit 211 is configured to identify the user 106 (as shown in FIG. 1) using the received user identity information. The user identifier unit 211 is configured to utilize the user identity information received from the portable communication device 108 via the communication network 109 (as shown in FIG. 1). The user identity information is transmitted to the user identifier unit 211 upon or after tapping the portable communication device 108 on an NFC or QR code or bar code. Specifically, the user identifier unit 211 is configured to identify the user 106 (as shown in FIG. 1) by comparing the user identity information such as a unique user ID received by the personalized content delivery device 110 when the user scans the matrix code, with the user identity data 200 stored in the memory 116 of the personalized content delivery device 110. In some other embodiments, the user identity information may include one or more of a portable communication device ID, an employee ID, an application ID, a mobile number, a loyalty card number, a social security ID, and combinations thereof.

In some embodiments, the user identifier unit 211 may be an Application Program Interface (API) when the user identifier unit 211 is implemented in the portable communication device 108 of the user 106. The API may receive the user identity information from the application 107 and/or the browser when the user 106 taps or scans the tag 104.

In some embodiments, the user identity data 200 may include the user identity information along with corresponding user profile information. The user profile information may include information about a name of the user 106. The user profile information may include information pertaining to previous registration of the user 106 with the retail store. The user profile information may include information such as an age and/or demographic of the user 106. For example, the user profile information may include a gender, a nationality, and/or a residential address of the user 106. In some embodiments, the user profile information may include information about a company name or store name the user 106 is working for.

According to an exemplary embodiment, the user identifier unit 211 utilizes user identity data 200 previously stored in the memory 116 of the personalized content delivery device 110. The user identifier unit 211 may compare the user identity data 200 with the user identity information received by the personalized content delivery device 110. For example, when the user identifier unit 211 recognizes that the user identity information such as a unique user ID received from the portable communication device 108 of the user 106, matches with the corresponding user identity data 200 stored in the memory 116, then the identity of the user 106 is identified and confirmed. For example, if the user identity information matches the corresponding user identity data of a registered user then the user identifier 211 may identify the user 106 as a registered user. In some embodiments, if the user identity information matches the corresponding user identity data of a staff member at the corresponding retail store then the user identifier 211 identifies the user 106 as a store staff member. In some embodiments, if the user identity information received by the personalized content delivery device 110 does not match with the user identity data 200 stored in the memory 116 then the user identifier 211 identifies the user 106 as a new user.

According to an exemplary embodiment, based on the identity of the identified user, the user data extractor unit 212 extracts user history data 201. In one embodiment, the user data extractor unit 212 of the personalized content delivery device 110 is configured to extract user history by accessing the user history data 201 when the user identity information received from the user 106 via the application 107 installed in the portable communication device 108. In second embodiment, the user data extractor unit 212 is configured to access the database associate with the merchant facility 102 to extract user history when the user identity information received from the user 106 from the browser. For example, when the tag 104 scanned or taped using the built-in camera or NFC reader associated with the portable communication device 108 which indeed enables the transmission of the user identity information to the personalized content delivery system 110 using the browser through the communication network 109.

In some embodiments, the user history data 201 includes shopping information, product preference information, brand preference information, frequency of purchase information, online browsing data, recently viewed items on-line, color preference information etc. Specifically, the user data extractor unit 212 is configured to extract user history data 201 corresponding to each identified user. For example, if the user identifier unit 211 identifies that the user 106 is a registered user, then the user data extractor unit 212 extracts user history data 201 corresponding to the identified registered user. In another embodiment, if the user identifier unit 211 identifies that the user is a staff member or employee at the retail store, then the user data extractor unit 212 extract user history data 201 corresponding to the identified staff member or employee.

According to an exemplary embodiment, the user data extractor unit 212 also extracts user location data 202. In some embodiments, the user data extractor unit 212 may be configured to extract location data corresponding to each identified user. In some embodiments, the user data extractor unit 212 may be configured to extract location data of certain categories of identified users such as registered users and new users. For example, if there is a local event such as a football match happening at a locality near the merchant facility 102 being visited by the user 106 whose location data confirms his/her presence in that locality, then the personalized content delivery device 110 may personalize the personalized template displayed on the user's device in a manner such that template's background contains the colors of one of the football teams playing the match. In this embodiment, the personalized content delivery device 110 may be configured to acquire details pertaining to the local event by being connected to a relevant third party database.

According to an exemplary embodiment, the personalized content delivery device 110 is also configured to receive and process a user's font style and font size data 203 to enable building a personalized content printed in the identified user's preferred font style and font size. In an embodiment, the font style and font size recognizer unit 216 is configured to extract and process font style and font size data 203 corresponding to an identified user.

In some embodiments, the font style and font size recognizer unit 213 may be an Application Program Interface (API) when the font style and font size recognizer unit 213 is implemented in the portable communication device 110 of the user. The API may acquire the color preferences, preferred language, font style and font size information from text messaging and e-mail messaging applications of the communication device 110.

In some embodiments, Artificial Intelligence (AI) techniques may be used to implement the font style and font size recognizer unit 213. In some other embodiments, Machine Learning (ML) techniques can be used to implement the font style and font size recognizer unit 213. In other embodiments, a combination of AI and ML techniques may be used to implement the font style and font size recognizer unit 213.

According to an exemplary embodiment, the content builder unit 214 is configured to generate a personalized content based on extracted data corresponding to the identity of the identified user. In an embodiment, the personalized content may include, but not limited to, text, numerals, signs, symbols, colors, graphics/Graphics Interchange Format (GIF) or combination thereof. The extracted data includes the user identity data 200, a user history data 201, a user location data 202, a user font style and font size data 203, and other data and also data from the database. In some embodiments, the data from the database comprises at least one of store's planogram information, shelf's images with location, geospatial information, user history data, images of the store floors, location of the communication device, product code lookup table, information about products sold in the store, products stored in the shelves, product manufacturing and expiry date information. The user profile information extracted from the user identifier unit 211, the history data 201 extracted by the user data extractor unit 212, the corresponding user location data 202 extracted by the user data extractor unit 212, user font style and font size data 203 extracted by the font style and font size recognizer unit 213 and other data 204 extracted by the user data extractor unit 212 In some embodiments, the data from the database extracted by the user data extractor unit 212. In some embodiments, the other data 204 may include data pertaining to time of entry of the user 106 into the retail store 102.

In one exemplary embodiment, based on the identity of the user identified, the user interface template selector unit 215 is configured to select a corresponding user interface template data 204 stored in the memory 103. In another exemplary embodiment, based on the user font style and font size data 203, the user interface template selector unit 215 is configured to select a corresponding user interface template data 204 stored in the memory 103. In an embodiment, the user interface template data 204 comprises different size templates, and different shape templates. The different shape templates comprises at least one of circle shape, square shape, rectangular shape, triangle shape, oval shape, star shape or combinations thereof. The different size templates comprise a small size template, a medium size template, a large size template, a phone specific template, or a standard mobile screen size based. In one example, a user interface template selected for a regular user may be different from a user interface template selected for a new user. Similarly, a user interface template selected for a staff member may be different from that selected for either a regular user or a new user. For instance, the user interface template selector unit 215 may select rectangular shape template with triangle shape edges for one user and the circle shaped template for another user. In another example, if the age of the user as identified by the user identifier unit 211 (shown in FIG. 2) is above fifty years then the font size printed may be twenty and the font style may be bold accordingly the user interface template selected by the user interface template selector unit 215. For instance, larger size template is selected. Similarly if the age of the user as identified by the user identifier unit 211 (shown in FIG. 2) is twenty five years then the font size printed may be twelve and the font style may be normal accordingly the user interface template selected by the user interface template selector unit 215. For instance, medium size template is selected.

The selected user interface template is used by the personalized template renderer unit 216 to embed the personalized content built by the content builder unit 214 into the selected user interface template selected by the user interface template selector unit 215 to generate a personalized template. Further, the personalized template 118 (as shown in FIG. 1) is delivered to the portable communication device 108 of the user 106 and displayed therein by the personalized template renderer unit 216 based on one or more characteristics related to the portable communication device 108. In some embodiment, the personalized template renderer unit 216 is configured to identify one or more characteristics related to the portable communication device 108 by sending access request to the portable communication device 108. In an embodiment, the one or more characteristics comprises at least one of screen size of the portable communication device, screen color capabilities of the portable communication device, bandwidth connection or internet speed of the portable communication device. In one example, the personalized template renderer unit 216 identifies that the portable communication device 108 has low bandwidth and poor screen quality, then the personalized template renderer unit 216 sends the personalized template in a simple text form. In another example, the personalized template renderer unit 216 identifies that the portable communication device 108 has good bandwidth and good screen quality, then the personalized template renderer unit 216 sends the personalized template 118 including text, graphics and numerals.

In some embodiments, when the user as identified by the user identifier unit 211 is a staff member, then based on the identity of the staff member identified, the user data extractor unit 213 may extract the corresponding user history data 212. For example, in this embodiment, the user history data 212 may include details of the one or more shopping aisles, products, staff members, and/or issue types managed by the respective staff member. In this embodiment, the user history data 212 may include a map or a layout image of the shopping aisles managed by the respective staff member. Based on the user history data extracted, the content builder unit 214 may build personalized content to be displayed on the communication device of the respective staff member. For example, the personalized content generated for display may include the number of units of a particular consumer product to be replenished on a particular shelf in the respective shopping aisle managed by the respective staff member. Also, the user interface template selected for embedding the personalized content in this instance would be different from that selected for a buyer/customer at the retail store. A staff member at the retail store can easily and promptly replenish shelves by looking at the personalized template delivered on his/her communication device.

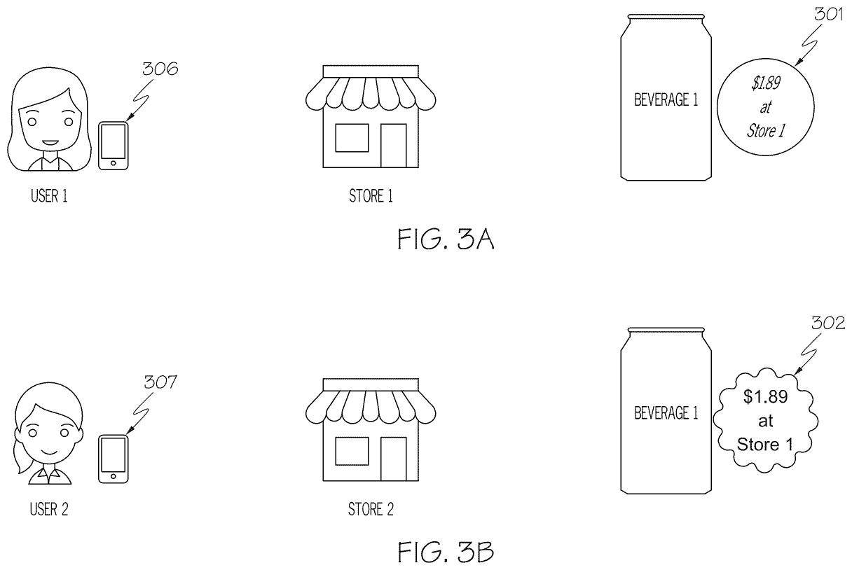

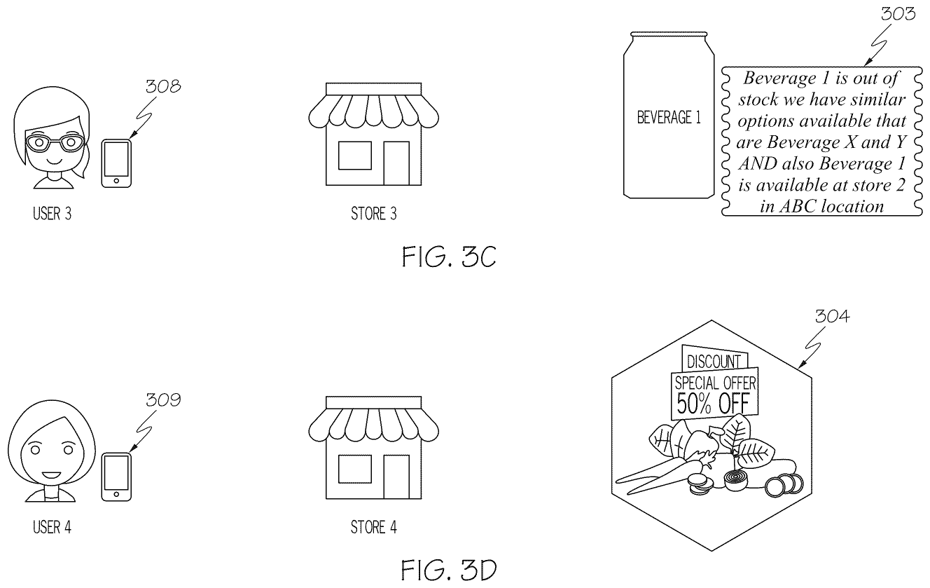

FIGS. 3A-3D illustrate different embodiments of personalized templates embedded with personalized contents that may be displayed simultaneously on portable communication devices (306, 307, 308, 309) of different categories of users present at one or a plurality of stores. The one or plurality of stores may be associated with a single merchant facility 102 (as shown in FIG. 1). In some embodiments, the different categories of users may comprise one or more of a first user, a second user, a third user, and a fourth user. In some embodiments the plurality of stores comprises a first store, a second store, a third store, and a fourth store. In an embodiment, the first user, the second user, the third users and the fourth user may be one of a regular customer, a new customer, a staff member, officer, owner, or an employee.

FIG. 3A illustrates an exemplary illustration of a personalized template 301 to be displayed on the portable communication device 306 of the first user, in accordance with some embodiments of the present subject matter. In one example embodiment, the first user such as a regular customer enters the first store with the portable communication device 306 such as a mobile device. The application 107 (as shown in FIG. 1) installed in the portable communication device 306. The personalized content delivery device 110 (as shown in FIG. 1) receives and identifies user identity, when the first user scans or taps the tag 104 (as shown in FIG. 1) using the application 107 via the communication network 109 (as shown in FIG. 1). The personalized content delivery device 110 presents a generated personalized template 301 embedded with a personalized content such as a discounted price of Beverage 1 for the first user/buyer/the regular customer present at the first store on the portable communication device 306. The personalized content delivery device 110 generates the personalized template 301 embedded with the personalized content based on the data corresponding to an identity of the identified user. The personalized content delivery device 110 presents or display the personalized template 301 embedded with the personalized content on the portable communication device 306 by considering the one or more characteristics related to the portable communication device 306.

In another example embodiment, the personalized content delivery device 110 delivers or presents coupon on the POS device (not shown Fig), when the first user such as a staff member scans or taps the tag 104 (i.e., the NFC tag, or the QR code tag, or the barcode tag) associated with the product 103 (as shown in FIG. 1) using the POS device. For example, the product 103 may be shampoo bottle with Z brand. Such delivered/presented coupon on the POS can be used as physical coupon on the similar products that is shampoo bottles with Z brand. For instance, the physical coupon can be created by printing the delivered or presented coupon the POS using a printer or any suitable printing device known in the art.

FIG. 3B illustrates an exemplary illustration of a personalized template 302 to be displayed on the portable communication device 307 of the second user, in accordance with some embodiments of the present subject matter. In another example embodiment, a second user such as a new customer may enter the second store with a portable communication device 307 such as a mobile device. The personalized content delivery device 110 may then generate and present a personalized template 302 embedded with a personalized content such as a discounted price of Beverage 1 for the second user/buyer on the portable communication device 307 in response to scanning or tapping the tag 104.

FIG. 3C illustrates an exemplary illustration of a personalized template 303 to be displayed on the portable communication device 308 of the third user, in accordance with some embodiments of the present subject matter. In another example embodiment, a third user such as a new user may enter a third store with a portable communication device 308 such as a mobile device. The personalized content delivery device 110 then generates and presents a personalized template 303 embedded with a personalized content such as Beverage 1 is out of stock, when the third user scans the tag 104 attached to the Beverage 1. Further the personalized content delivery device 110 may present personalized content which includes customized alternative choices, such as based on the third user's preferences and/or the third store's inventory or current promotions. The customized alternative choices may include alternative similar products, an alternate store or brand name, and/or a location for the alternative product (i.e., for Beverage 1).

FIG. 3D illustrates an exemplary illustration of a personalized template 304 to be displayed on the portable communication device 309 of the fourth user, in accordance with some embodiments of the present subject matter. In another example embodiment, a fourth user such as a regular user may enter a fourth store with a portable communication device 309 such as a mobile device. The application 107 may be installed in the portable communication device 309. The personalized content delivery device 110 may generate and present a personalized template 304 embedded with a personalized content such as a customized discounted price on required products/vegetables for the fourth user/buyer at the fourth store on the portable communication device 309 that is different from each of the content delivered to the first user, the second user, and the third user. The personalized content delivery device 110 may generate the personalized content shown in the template 304 by accessing at least one of the application 107, online browsing data, and recently viewed items on-line by the fourth user, or combinations thereof. For example, based on tracking and accessing at least one of the application 107, online browsing data and recently viewed items on-line, the personalized content delivery device 110 may identify that the fourth user is planning to prepare vegetable soup. Accordingly, the personalized content delivery device 110 may generate the personalized content such as a discount on required products/vegetables for the preparation of the vegetable soup as shown in the template 304.

As illustrated in the embodiments, the font style and font size of the personalized content may automatically be made different in every personalized template (i.e., 301, 302, 303 and 304) based on the corresponding personalized content built for a respective identity of the user (i.e., for the first, second, third, and fourth users) as identified by the personalized content delivery device 110. For example, if the age of the user as identified by the user identifier unit 211 (shown in FIG. 2) is above fifty years then the font size printed may be twenty and the font style may be bold. In another embodiment, if the font style as recognized by the font style and font size recognizer unit 213 is Calibri then the contents of the personalized template may be presented in Calibri. In another embodiment, if the user data extractor unit 212 utilizing the user history data 201 identifies a user's favorite color, then the template renderer unit 216 may render the personalized template in the same color.

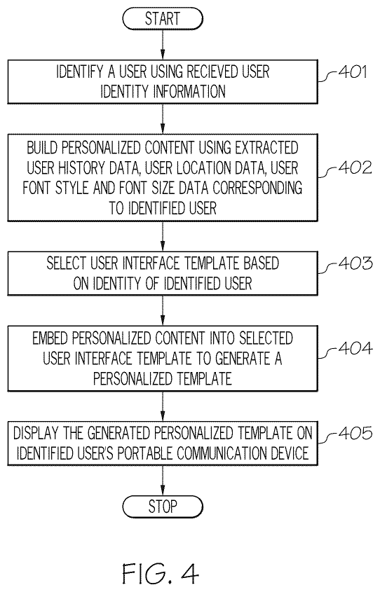

FIG. 4. illustrates a flowchart depicting an exemplary method for delivering personalized template to the portable communication device 108 (as shown in FIG. 1) of the user 106 (as shown in FIG. 1), in accordance with some embodiments of the present subject matter. The method steps are performed using the personalized content delivery device 110 (as shown in FIG. 1). The order in which the method may be described is not intended to be construed as a limitation, and any number of method steps may be combined in any order to implement the method. Additionally, individual blocks may be deleted from the method without departing from the spirit and scope of the subject matter described herein. Furthermore, the method may be implemented in any suitable hardware, software, firmware or combinations thereof.

At step 401 the personalized content delivery device 110 identifies the user 106 using received user identity information. The personalized content delivery device 110 receives user identity information from the portable communication device 108 via the communication network 109 (as shown in FIG. 1) when the user 106 taps or scans the tag 104 (as shown in FIG. 1). The personalized content delivery device 110 comprises the processor 112 (as shown in FIG. 1) and a memory 116 (as shown in FIG. 1) communicatively coupled to the processor 112. The user identity information including the user profile information is processed by the processor 112 to identify the user. At step 402, based on the identity of the user identified, the processor 112 is configured to execute a series of instructions/data to build a corresponding personalized content. In an exemplary embodiment, the personalized content is built using the extracted user identity data, user history data, user location data, user font style and font size data, other data and data from the database associated with the merchant facility 102 (as shown in FIG. 1). The user profile information extracted from the user identifier unit 211, the history data 201 extracted by the user data extractor unit 212, the corresponding user location data 202 extracted by the user data extractor unit 212, user font style and font size data 203 extracted by the font style and font size recognizer unit 213, other data 204 extracted by the user data extractor unit 212 and the data from the database extracted by the user data extractor unit 212. Based on the extracted data, the personalized contents for a particular user may be created. For example, using the above-mentioned data, the price discount details to be displayed and its format may be generated. At step 403, the personalized content delivery device 110 selects the user interface template to be displayed, such as based on the identity of the identified user. In some embodiments, the personalized content delivery device 110 may be configured with a user interface template selector unit 215 for selecting the respective user interface template. Further, at step 404, the selected user interface template is used to embed the personalized content built in step 403 to generate the personalized template 118 (as shown in FIG. 1). Finally, at step 405, the generated personalized template 118 is delivered to the portable communication device 108 of the user 106 and displayed therein by the personalized template renderer unit 216 based on one or more characteristics related to the portable communication device 108. In some embodiment, the personalized template renderer unit 216 is configured to identify one or more characteristics related to the portable communication device 108 by sending access request to the portable communication device 108.

What has been described above includes examples of the claimed subject matter. It may be, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter may be intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A personalized content delivery system comprising:
a personalized content delivery device communicatively coupled to a portable communication device of a user via a communication network, wherein
the personalized content delivery device is configured to identify an identity of the user and deliver a personalized template for display on the portable communication device of the identified user, and wherein the personalized template is embedded with personalized content generated based on the identity of the identified user.

2. A personalized content delivery system for displaying a personalized template on a portable communication device of a user, the personalized content delivery system comprising:
a personalized content delivery device communicatively connected to the portable communication device via a communication network, wherein the personalized content delivery device is configured to:
identify a user based on a user identity information received;
generate a personalized content based on extracted data corresponding to an identity of the identified user;
select a user interface template based on the identity of the identified user;
embed the generated personalized content into a selected user interface template to generate the personalized template; and
display the generated personalized template on the portable communication device of the user.

3. The personalized content delivery system of claim 2, wherein the extracted data comprises a user identity data, a user history data, a user location data, a user font style and font size data, and other data or any combination thereof.

4. The personalized content delivery system of claim 2, wherein the extracted data further comprises data from a database associated with a merchant facility.

5. The personalized content delivery system of claim 4, wherein the data from the database comprises at least one of store's planogram information, shelf's images with location, geospatial information, user history data, images of the store floors, location of the communication device, product code Lookup table, information about products sold in the store, products stored in the shelves, product manufacturing and expiry date information.

6. The personalized content delivery system of claim 2, wherein the personalized content delivery device is further configured to:
identify one or more characteristics related to the portable communication device; and
display the generated personalized template on the portable communication device of the user based on the identified one or more characteristics.

7. The personalized content delivery system of claim 6, wherein the one or more characteristics related to the portable communication device comprises at least one of screen size of the portable communication device, screen color capabilities of the portable communication device, bandwidth connection or internet speed of the portable communication device.

8. The personalized content delivery system of claim 2, wherein the portable communication device is operated or accessed through a browser or an application.

9. The personalized content delivery system of claim 2, wherein the personalized content delivery device comprises a processor and a memory communicatively coupled to the processor.

10. The personalized content delivery system of claim 9, wherein the processor is configured to acquire the user identity information from the portable communication device via the communication network upon the user scanning/tapping a tag.

11. The personalized content delivery system of claim 10, wherein the tag comprises a NFC tag, a barcode tag, a matrix code tag, a QR code tag, or combination thereof.

12. The personalized content delivery system of claim 2, wherein the portable communication device is any of a mobile phone, Point-Of-Sale (POS) device, a smart phone, a tablet, a laptop, handheld computer or any combination thereof.

13. The personalized content delivery system of claim 9, wherein the processor is configured to acquire the user identity information from the browser of the portable communication device via the communication network upon the user scanning/tapping the tag.

14. The personalized content delivery system of claim 13, wherein scanning/tapping is configured to be performed using built-in camera or NFC reader associated with the portable communication device.

15. The personalized content delivery system of claim 9, wherein the processor acquires the user identity information from an application associated with the portable communication device via the communication network when user taps or scans the tag using the application.

16. The personalized content delivery system of claim 9, wherein the user identity information from the portable communication device is transmitted to the processor by tapping the portable communication device on the NFC tag using one of the built-in NFC reader or the application associated with the portable communication device.

17. The personalized content delivery system of claim 9, wherein the user identity information from the portable communication device is transmitted to the processor by scanning the barcode or matrix code or the QR code using one of the built-in cameras or the application associated with the portable communication device.

18. The personalized content delivery system of claim 2, wherein the user identity information is selected from a group consisting of a unique user ID, an employee ID, an application ID, a mobile number, a loyalty card number and social security ID.

19. The personalized content delivery system of claim 2, wherein the personalized content delivery device is a proxy server.

20. The personalized content delivery system of claim 2, wherein the personalized content delivery device comprises a plurality of functional units including a user identifier unit, a user data extractor unit, a font style and font size recognizer unit, a content builder unit, a user interface template selector unit and a personalized template renderer unit.

21. The personalized content delivery system of claim 9, wherein the memory is configured to store data comprising user identity data, user history data, user location data, user font style and font size data, user interface template data and other data.

22. The personalized content delivery system of claim 19, wherein the user identifier unit is configured to utilize the user identity information and the user identity data corresponding to the user identity information to identify the identity of the user.

23. The personalized content delivery system of claim 21, wherein the user identity data includes user profile information.

24. The personalized content delivery system of claim 2, wherein the personalized content includes customized discounted price information for a product.

25. The personalized content delivery system of claim 2, wherein the personalized content includes customized alternative choices for a product.

26. The personalized content delivery system of claim 25, wherein the customized alternative choices comprises at least one of alternative similar products and alternative store name with location for the product.

27. The personalized content delivery system of claim 2, wherein the personalized content includes customized discounted price on a required product for the user.

28. The personalized content delivery system of claim 27, wherein the required product is configured to be identified by the personalized content delivery device by tracking and accessing at least one of the applications, online browsing data, and recently viewed items on-line by the user.

29. The personalized content delivery system of claim 2, wherein the personalized template comprises a template with customized shape and size for the identified user.

30. A personalized content delivery device, comprising:
a processor; and
a memory communicatively coupled to the processor, wherein
the processor is configured to:
identify a user based on a user identity information received;
generate a personalized content based on extracted data corresponding to an identity of the identified user;
select a user interface template based on the identity of the identified user;
embed the generated personalized content into a selected user interface template to generate a personalized template; and
display the generated personalized template on a portable communication device of the user.

31. A method for delivering a personalized template to a portable communication device of a user, the method comprising steps of:
identifying a user using received user identity information;
generating a personalized content based on extracted data corresponding to an identity of the identified user;
selecting a user interface template based on the identity of the identified user;
embedding the generated personalized content into a selected user interface template to generate the personalized template; and
displaying the generated personalized template on the portable communication device of the user.

32. The personalized content delivery system of claim 20, wherein the user identifier unit is configured to utilize the user identity information and the user identity data corresponding to the user identity information to identify the identity of the user.
